(19) United States
(12) Patent Application Publication
(10) Pub. No.: US 2013/0212191 A1
(43) Pub. Date: Aug. 15, 2013

(54) DEVICE-AGNOSTIC NETWORK AND SOCIAL NETWORK SHARING OF... WEB-APPLICATIONS

(71) Applicants: Kika Suraj, Stonygate (GB); Andrew Perkins, Shepshed (GB)

(72) Inventors: Kika Suraj, Stonygate (GB); Andrew Perkins, Shepshed (GB)

(73) Assignee: WEEJOT LTD., LEICESTER (GB)

(21) Appl. No.: 13/585,353

(22) Filed: Aug. 14, 2012

Related U.S. Application Data
(60) Provisional application No. 61/575,191, filed on Aug. 17, 2011.
(60) Provisional application No. 61/575,192, filed on Aug. 17, 2011.

(51) Int. Cl. H04L 12/58

(52) U.S. Cl. CPC H04L 51/32
USPC 709/206; 709/204

(57) ABSTRACT

A Software as a Service framework that supports the creation and adoption of web-application availability to users' contacts without needing technical knowledge of computer code, network architectures, devices, or protocols. Forwarding is controlled by sending a link through said framework over SMS, MMS, email, social networks, etc. Depending upon permissions set by the application's owner, a recipient may also forward the web-application link to his/her own contacts, promoting viral propagation of the web-application's availability. Recipients may also be granted permission by the web-application's owner to contribute towards its functionality and/or its source data, enabling crowd-sourced enhancement of the web-application. Web-applications developed within said framework may be utilized and distributed via any web-enabled device able to access the link to the web-application. Restrictions may be imposed by the web-application owner regarding the duration and/or number of accesses permitted to it.

### CROSS-REFERENCE TO RELATED APPLICATION

This application claims priority to U.S. provisional application Ser. No. 61/575,191, filed 17 Aug. 2011, which is hereby incorporated by reference in its entirety.

Principles for the non-technical creation of web-applications as performed through the SaaS framework are considered within separate U.S. provisional application Ser. No. 61/575,192, filed 17 Aug. 2011, the disclosure of which is also claimed for priority and which is hereby incorporated by reference in its entirety.

### FIELD OF THE INVENTION

This invention relates to methods for large scale adoption and sharing of web-applications to all web enabled devices, where the web-applications have been prepared and published for consumption through an application or framework connected to a Wide Area Network (WAN). Said web-applications are initially created by individuals within the application or framework in a non-technical manner, and are then distributed via a number of potential mechanisms, such as SMS, MMS, BBM, emailed link, social network messaging, and any other modern approaches for Push notifications to a selected social community or group of consumers. Such web-applications can be configured during the publication process to extend beyond simple sharing capabilities, to accommodate also social contributions to the included data and the viral forwarding of the availability of such web-applications and their associated data to a recipient's own social communities in turn.

### BACKGROUND OF THE INVENTION

With the rapid growth of social networking platforms and websites such as Facebook, LinkedIn, Twitter, Google+, Pinterest to name but a few, the World Wide Web (WWW) or Internet has become a social communications phenomenon, engaging tens of millions of people all over the world every day. All people engaged in the use of such social networks are effectively content publishers, sharing content frequently with their friends, social groups or other online communities from the vast array of web-enabled devices that have empowered their thoughts, feelings, and ideas to be pushed by such individuals with the greatest of ease as content through these social networks.

“Whether it's consumers looking for a phone that can tap into several robust ‘app’ ecosystems, businesses looking at deploying tablet devices into their environments, or educational institutions working to update their school's computer labs, smart, connected, compute-capable devices are playing an increasingly important role in nearly every individuals life”, said Bob O'Donnell, vice president, Clients and Displays at the International Data Corporation (IDC).

Research conducted by the IDC suggests that many individuals own and regularly use multiple smart connected devices. “We are in the multi-device age,” continued O′Donnell, “and we believe the number of people who use multiple devices will only continue to increase. The trick, moving forward, will be to integrate all these devices into a unified whole through use of personal cloud-type applications and services.”

For instance today, we have smart phones and other mobile computing devices, including tablets, smart televisions, games consoles as well as the more traditional laptop and desktop devices. With this increase in demand and the breadth of such devices, the consumption of web ‘apps’ has accelerated even faster with each device using multiple apps, for instance one app per social network within which the user is a member is a bare minimum.

Native mobile ‘App’ downloads have accelerated in the twelve month period, 2011-2012. Recent research undertaken by Nielsen, reveals that the average number of apps per smart phone has seen a 28% rise in the last year, where users of iOS devices download an average of 40 apps, while users of Android and BlackBerry devices download an average of 25 and 14 apps respectively.

Looking ahead, unit shipments for smart connected devices should top 1.1 billion worldwide in 2012. By 2016, IDC predicts shipments will reach 1.84 billion units, more than double the 2011 figure, as consumers and business of all shapes and sizes around the world are showing a nearly insatiable appetite for smart connected devices.

The advancement in web technologies and device capabilities coupled with the growth of social networks, collaborative publishing and user generated content (e.g. wikis) has merged technological and social landscapes, creating the foundations from which new communities emerge and connect through a range of associations. The basis upon which these communities emerge and connect increases at a rapid rate through associations between individuals, referrals to larger groups, creation and merging of entire communities and organizations.

The proliferation of API services for these networks enables the content and data within such social content stores to be used for the creation of other applications and the sharing of content and data across other media and devices. Combined with the proliferation of web enabled devices able to access such services, content and data can be exposed rapidly by consumers, creating new audiences and patterns of adoption/consumption.

Using the principles of the World Wide Web, and recent developments in web browser technologies, it is easier than ever before to present websites or web-applications in ways that are optimized for the capabilities of different devices. web-applications deployed and available through a URL can be developed to provide a native app like experience, without some of the barriers or overheads that exist with native application development. Such examples could include the need for these to be built using specific programming languages and libraries for each individual target device by a developer who understands how to program in each languages such as Apple iOS apps would be developed using the Objective-C language, Google Android and RIM Blackberry use Java and so on. There are also the large number of concepts that the framework will handle on behalf of the end user which through native application development would not be provided, such as automated and disseminated updates (to both the underlying application and data), the presentation upon each device, the single code base used by all devices rather than distinct targeted apps to name but a few.

Although a website optimized for a mobile device cannot, at the moment, reliably take advantage of all the device's features, it does offer the user the ability to rapidly develop apps, change the mobile user's experience of the site's content quickly, and rapidly develop so called web apps for mobile device consumption. Using features of HTML5, apps deployed on a website can provide a truly mobile experience where, for example, geo-location services provide information local to the user, while local storage of content on the device can greatly speed up the experience for the user through the device's offline capability.

### SUMMARY OF THE INVENTION

The invention pertains to a framework, comprised of software and technological infrastructures, coupled with social networks and other communication protocols for the sharing of social web-applications, created technically or non-technically through said framework. Depending upon access levels defined within the web-application or by the user at the point of sharing, individuals or groups can forward the web-application through their own additional contacts or social connections, whilst also potentially contributing to the content provided by the web-application(s).

The device-agnostic sharing network leverages capabilities of existing social networks and other widely available communication channels to extend a framework of shared web-applications through devices including, but not limited to traditional desktop and laptop computers, tablets, mobiles, smart phones, smart televisions, and gaming consoles using the World Wide Web (WWW).

Network sharing within this framework is achieved through server based technology within a Software as a Service (SaaS) platform, such as the sharing and promotional listings of content rich web-applications created upon a web-enabled device, that no technical knowledge has been required to create in order to accelerate the creation, provision, consumption, knowledge acquisition and proliferation of web-applications around the world.

Within the device-agnostic sharing network, viral sharing and adoption of web-applications occurs through communities where connections exist across and between interdependent networks and social groups/communities that may be connected through specific relationships or virtual and technological associations.

Access to a specified audience and groups of contacts to the web-application is based upon a setting made by the web-application owner at publication. This can specify a shared web-application's status as being public/private and whether those wider audiences can then in turn reforward the web-application in a typical viral model of forwarding and large scale adoption (an individual will share with another or more, triggering an increased repetition of the same forwarding process). An additional setting permits the contribution upon the web-application's content by those users with which the application has been shared in a crowd-sourced manner.

This contribution may then in turn be used to further promote the web-applications availability and continued use via the pushing of additional communications (similar to those used when initially sharing the application), but this time to mention that new content has been pushed and by whom within what application, in the cases that the contributor is proud of or thinks that their friends or all application users might find interesting or useful.

The device agnostic sharing network utilizes communications mechanisms such as SMS/MMS, BBM (BlackBerry Messenger), Email or functionality prevalent within web based social networks for sharing across an individual's contacts directories or associative groups.

Building upon more traditional media and web technologies, patterns of communication and web technology usage through the mobile channel, particularly smart phones, introduces shifts within technological approaches to how users interact and engage with individuals/organizations online and how these will manifest in the sharing of web-applications and associated functionality regardless of a receiving individuals particular device or comprehension of technical ability.

At the point of sharing via social network, just one of the embodiments of the present invention, communication through social networks or via other described communication protocols will alert prospective audiences (in some cases defined by an individual/organization) of the web-application's availability.

Within a device agnostic web-application sharing framework, certain web-applications enable account, profile and provisioning management features to control how the web-application will be forwarded. A framework account holder can create and share any number of web-applications and promote these through their account. Associated application settings can determine the degree to which a web-application is or can be forwarded (a shared web-application may be distributed and adopted virally depending on specifically defined privacy policies or settings). Such settings determine whether recipients can forward the web-application, whether individuals with whom the web-application has not been shared with can request access, and whether audiences can contribute to and extend content/data within the data store of the shared web-application at the framework. Further settings where contribution is permitted include moderation of such submitted data before contributions are committed to the production shared web-application, as well as facilities for audience participation towards the underlying content, if not directly editing the source data, such as comments and reviews.

### BRIEF DESCRIPTION OF THE DRAWINGS

FIG. 1 depicts the flow of activity in the sharing of web-applications through the framework. The end user sharing their web-application firstly creates their web-application within the SaaS framework via their web-enabled device of choice (Laptop or Tablet is depicted here), and publish this through any relevant workflow enforced by the framework as ready for public consumption. This is then shared via a multitude of options for communicating the availability of the web-application with the intended recipients, such as via the Internet (emailing of a URL to the web-application, or via such as a native Internet based sharing application and so on), via a mobile network (SMS, MMS, BlackBerry Messenger) or via a social network messaging capability, such as Facebook Messages to Groups of Friends, Google+ Circles, Twitter Tweets or Direct Messages, Pinterest, Linkedln messages and so on. The recipient may receive their message via their relevant web-enabled device that is able to receive the relevant format message, for example Netbooks, Smart Televisions, Smart Phones or Games consoles and may receive the WWW communication to access the web-application, whilst a mobile phone may be used to receive the message, and through a Social network this might be a Desktop, Tablet or Games console. The end user(s) through the message received via such mechanisms can then access the originating user's web-application served from within the framework within which the web-application was provisioned and appropriate access levels for the request checked prior to granting access and rendering the web-application interfaces.

FIG. 2 provides a non-limiting example that depicts the viral nature by which web-applications can be chosen to be shared through the SaaS framework. The web-application creator can assign permissions to the web-application such that they can control if other end users can simply access the application or not without invitation, whether recipients can then forward the web-application availability to their own defined audiences (e.g. friends and colleagues), such that the initial user might only share the web-application with an immediate audience comprising, for example, their closest ten friends through their Facebook Group (now 11 people have access assuming everyone accepted the invitation), but each of those friends may then in turn share the web-application with five of their mobile phone address book contacts via SMS (now 61 people have access assuming everyone accepted the invitation) and so on. If the web-application built through the framework is made ‘Public’ in terms of sharing, then it is also promoted through the framework itself, in a manner akin to that of an app-store like listing of published, public web-applications for users to locate without it being shared either directly or indirectly. Whilst this figure uses the example of a Restaurant app built through the framework, this is for illustrative purposes only and does not serve to limit the scope of this application for this purpose.

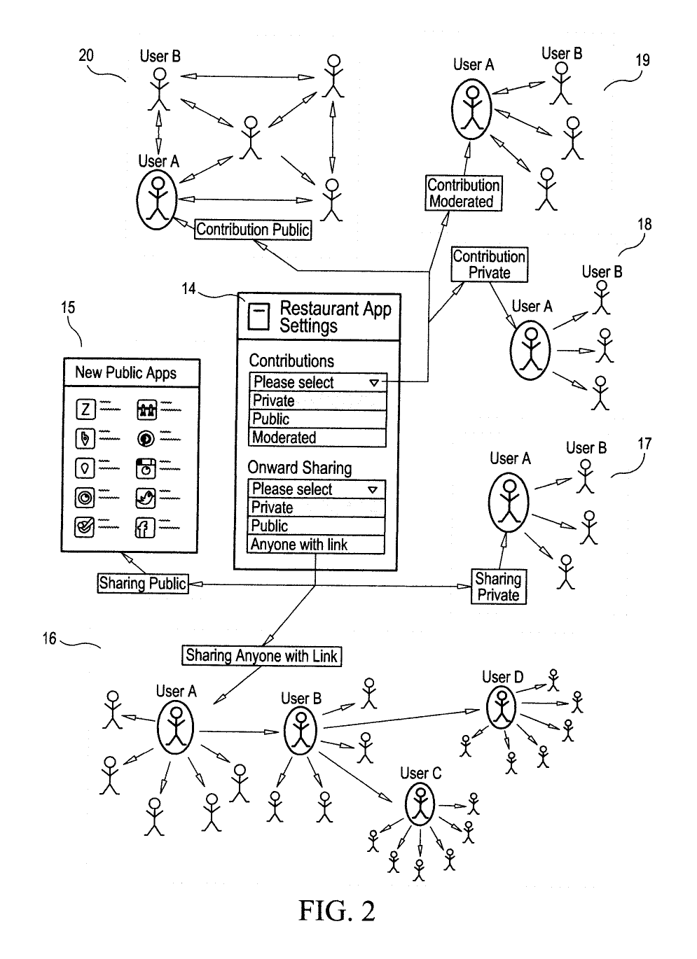

FIG. 3 depicts a possible User Interface implementation by which a web-application can be shared via a ‘Share’ icon represented in the task bar across the bottom of the User interface of the web-application, if indeed the end user accessing the web-application has the relevant permissions to forward access to their immediate audience (friends, contacts, networks and so on). This task bar also includes an icon for adding to the currently available set of data via ‘crowd sourced’ additions to the data as accessed/stored within the framework. The second user interface depicts a possible user interface for choosing from all of the available methods by which the web-application can be shared via invitation, dependant upon which networks might be available to the current user (e.g. a user who has not provided their Twitter credentials possibly as they do not have a Twitter account would not see the Twitter option).

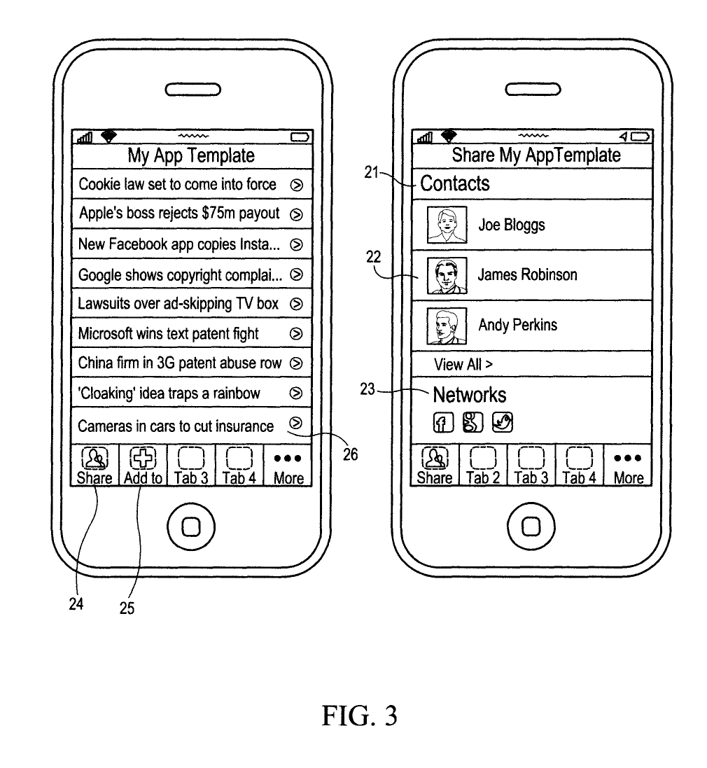

FIG. 4 non-limiting example that depicts the mechanism for the social generation of content/crowd-sourced content, that enables the promotion and contribution of content to a web-application, with optional workflow for the content owner to mediate content as it is submitted. Whilst this figure uses the example of a Restaurant listing and reviews application built through the SaaS framework, this is for illustrative purposes only and does not serve to limit the scope of this application for this purpose.

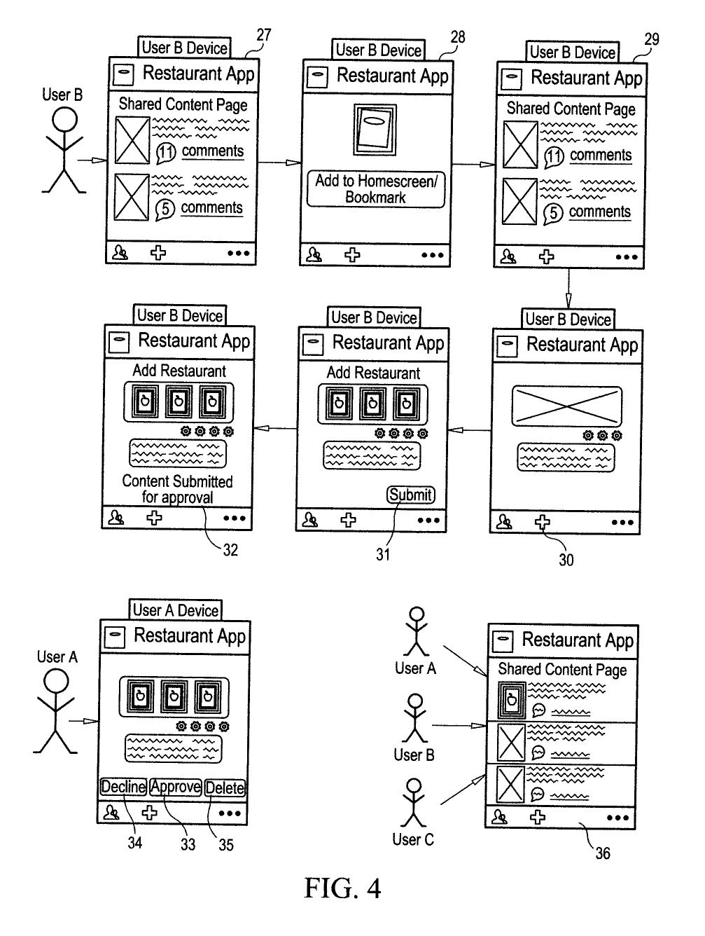

FIG. 5 depicts the process by which a recipient of access to a web-application via a device-specific communication mechanism (in this example an SMS message received upon a smart phone) may wish to share access to the web-application via another communication mechanism provided by the SaaS framework, with themselves (given that the relevant permissions are set to enable this). This would therefore allow the user to access the web-application from a separate web-enabled device that they own (in this example a laptop).

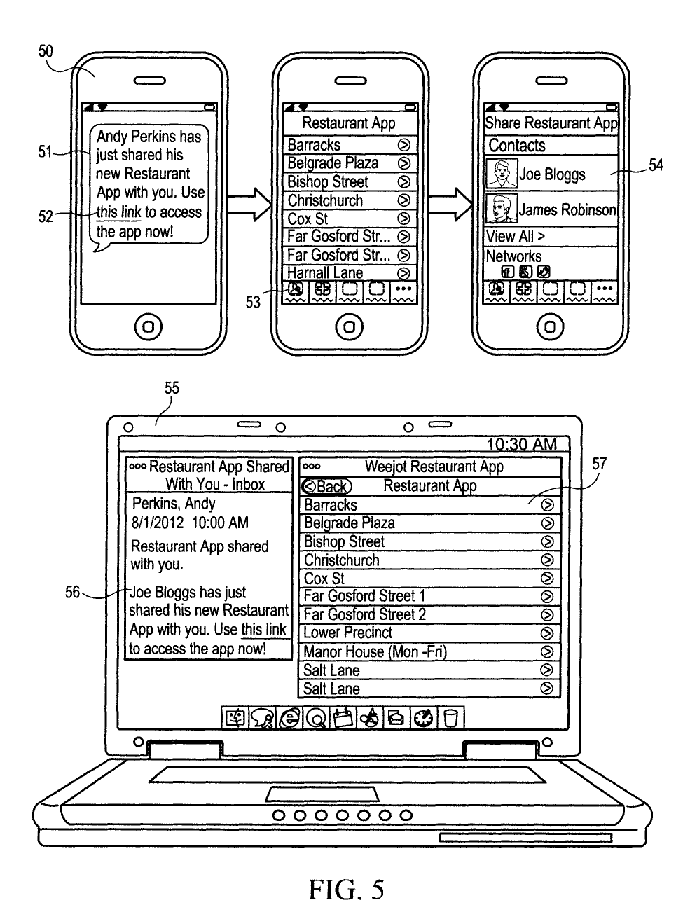

### DETAILED DESCRIPTION OF THE INVENTION

The present invention will be described more fully hereinafter with reference to the accompanying drawings which show, by way of illustration, specific embodiments by which the invention may be implemented. This invention may however be embodied in various different forms and should not be construed as limited to the embodiments herein. The following description is therefore not to be interpreted in that of a limiting manner.

The term ‘social network’ herein refers to the concept that an individual's personal network of friends, family, colleagues and the subsequent connections therein can be utilized for the purpose of virally communicating with a large number of connected users via the communication mechanisms that such social network sites as Facebook, Twitter, LinkedIn and so on offer.

The term ‘viral’ or ‘virally’ herein refers to the concept of marketing techniques that use pre-existing social networks to produce increases in awareness of a product or brand through a self-replicating viral process, analogous to the spread of viruses. It can be delivered by word of mouth or enhanced by the network effects of the Internet.

Within the proposed SaaS framework, any web enabled device can be used by the web-application creator to create, publish and share their web-application through the framework. Depending upon the web-application's configuration options at the point of publishing the web-application for public consumption, the workflow for which being managed by the SaaS framework, the web-application can be forwarded by recipients with whom the web-application was initially shared by the original creator, hereon in referred to as the web-application owner.

Sharing of a web-application can be achieved via a Uniform Resource Locator (URL) sent through any of the following example channels (but not limited to):
1. Internet/WAN (e.g. Email, Bump or other link sharing capability)
2. Mobile messaging (e.g. BlackBerry Messenger, SMS, MMS)
3. Social network messaging (e.g. using a Twitter Tweet or Facebook message/post)

The framework is the central point of control, facilitating the use of the wide range of web enabled devices and different individuals consuming web-applications, providing the relevant messaging and integration capabilities required to support at least those communication channels indicated above, providing the subsequent access control to web-applications published therein, controlling the relevant workflow required under certain settings within the web-application's configuration, and providing management reporting information for the owner to understand the uptake and effectiveness of the web-application that they have delivered.

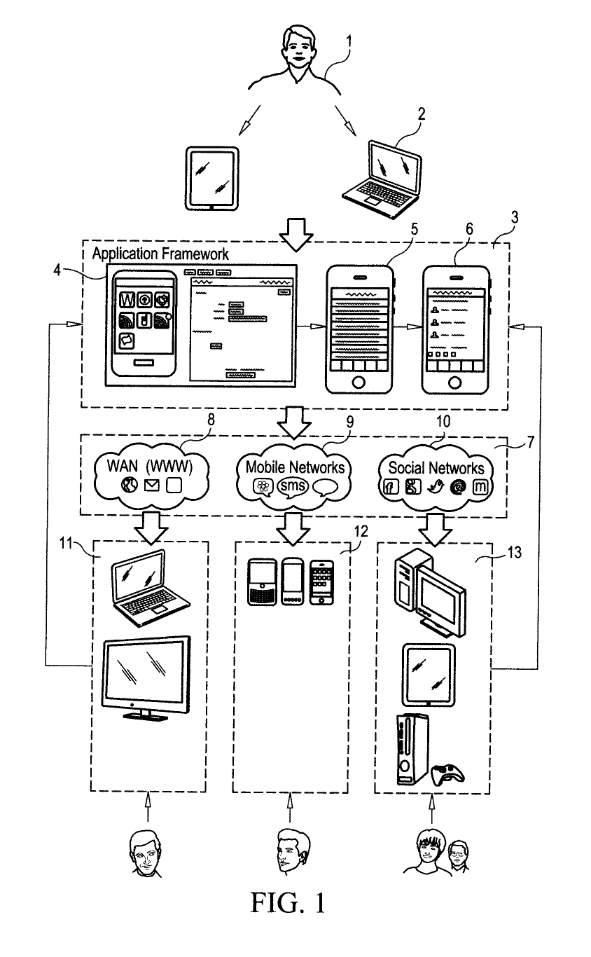

A typical example for the creation and publishing of a web-application non-technically is depicted in FIG. 1, whereby an individual (user A) 1 through their web enabled device (device A) 2 non-technically creates a web-application 4 within the SaaS framework 3 for production publication 5, making it available to other users with access to the WWW with a notification type of their choosing to the recipient users of their choice at 6.

The web-application can be shared or distributed from the framework through a number of communication networks 7, such as WAN 8 via emailed link or such as offered by the Bump application, for immediate consumption through a web connected device able to receive such a message, such as netbooks, smart televisions or Internet connected games consoles 11. Another embodiment may be communicating the availability of the web-application through mobile networks with notification through SMS, MMS or Instant Messaging (such as BlackBerry Messenger) 9 for provision and consumption through smart phones 12. A further embodiment may be making the web-application available through a multitude of current social networks 10 with notification through their respective communication mechanisms such as Facebook messages, Google+ alerts, Twitter tweets, LinkedIn messages, Pinterest and so on for immediate provision and consumption through desktop computers, tablet devices or games consoles that have been linked with the end-user's social network accounts accordingly 13.

The forwarding capability that enables the rapid adoption, viral sharing, and crowd sourcing of data, can be specified non-technically by the web-application owner at the point of creation or thereafter as necessary. Contribution and Sharing permission settings 14 specify whether an application is ‘Private’ (cannot be shared at all) or ‘Anyone with the link’ (can be shared with others who get access to the direct URL, shared or otherwise), and ‘Public’ (can be shared via link as previously described, but is also promoted through the SaaS framework itself in an appstore like fashion) 15. If audience contribution is enabled within the web-application (i.e. is not set to ‘Private’), settings can also be used to determine whether crowd sourced data is subject to moderation prior to inclusion in an application's data set. This moderation may be centrally performed by the web-application owner directly, or the owner may choose to elect a devolved management style whereby a number of web-application moderators/admins have the necessary permissions to perform this function on the owner's behalf. This provides the web-application owner with the ability to include/exclude/adjust data that is added to their application, providing a central point of control and management. Both Contribution and Sharing data settings (among others) are set by the web-application's originator upon each web-application that they create and share.

When the web-application forwarding settings are set to ‘Anyone with the link’ 16, users with whom the application is initially shared will have the ability to forward the application to their friends, colleagues and communities (i.e. User B can share with User C and so on). This facilitates the viral sharing capability of web-applications through the proposed SaaS framework.

If the web-application sharing is set to ‘Public’, then a publicly available framework-powered listing will include this (and other) web-applications built upon this platform within a directory of publicly available and published applications 15, much like a native app-store might be used to promote native mobile applications for vendor-specific devices/operating systems. It should be noted that any user who has access to a publicly shareable application can choose to further share the application with anyone else as was the case with ‘Anyone with the link’.

An application with sharing settings set to ‘Private’ 17 can still be shared, but only by the creator of the application with those that he explicitly shares the application with. Anybody with whom the application is shared with is unable to forward the application to anybody else, i.e. User B may not share the web-application with their friends.

An application's contribution settings 14 determine the level of control over an application's data that is possible by the end user. There are three settings suggested as a minimum, but this list should not be considered exhaustive at this time. The ‘Private’ setting means that only the creator of the application controls what data is stored by the web-application. When a user shares the application with other people they do not have the permission to contribute to the overall data available through the application 18. When an application is set to have moderated contribution permissions, users with whom the application is shared can submit data to be considered for inclusion within the application's data set 19. Data submissions by shared users must be moderated by the creator of the application who will have the option on whether to approve the data additions/updates/deletes to the application's data set or not. When the Contribution setting for an application is set to ‘Public’, then any person that an application is shared with can submit data to the application's data store without central moderation of their submitted content 20.

Mechanisms through which web-application access is granted may be influenced by the mechanism through which it is shared and any settings specified by the originator during this process. For example, sharing a web-application may invoke the automated creation of a link which includes an access verification token that is to be shared or specification of an access code in order to verify access by only appropriate personnel. Alternatively, the web-application may be shared with open access by the originator. The choice of these settings will determine the nature of forwarding by those with whom the web-application has been shared.

In sharing access with a set of users whilst the sharing setting is set to ‘Private’, a unique link is generated by the framework and sent to each contact with which the end user wishes to share the web-application. A link is an address on a network such as a Uniform Resource Locator (URL) which can include a token to grant access to the originator's web-application only.

It is left to the SaaS framework implementation to decide if a framework profile is enforced for use by a recipient as part of the web-application link acceptance, and therefore binding access control permissions to this profile account at the point of acceptance, rendering the forwarding of a private link unimportant for controlling further access by the end user, as this can be enforced by the end user's signed-in account status through the framework. Enforcing use of a profile account has the advantage of avoiding abuse of private link sharing, but adds a potential barrier to service take-up and delivery. Terms and Conditions would be required to discourage the forwarding of private access links where authenticated profile access was not enforced.

In its simplest embodiment, the link provided by the framework to the end user is unique such that it directs the receiving end user to the specific account within the SaaS framework upon which the web-application is implemented, and then to the specific application that has been shared with the recipient, whereby each framework account may provide more than one application within the account environment.

In another embodiment, the link shared provides a limited number of accesses to the application e.g. limited to only one use and then becomes invalid for subsequent uses. In such a case, the link would be unique for each of the contacts with which it was individually shared. Sending of a link in this manner would only make sense whereby the framework did not enforce authenticated profile based access.

In a similar embodiment, the link shared provides a time limited period of access rather than a limited number of successful accesses, such that content subscriptions (say for an annual period of access) and paid-for web-application access provision can become a possible delivery through the invention. The configuration of such link restrictions at the time of sharing the application shall lie within the settings provided through the framework, some of which are shown at 14 (this representation of settings is not considered exhaustive at this time).

Alternatively, the framework shall also provide a means by which recipients of web-application shares can create a profile within the framework itself to store links to their favourite/received web-applications list for ease of reference at a later stage if the device does not offer capabilities such as adding a shortcut to the home-screen or bookmarks as is offered on modern day smart phone devices. Through this framework provisioned profile, and from any type of device, the user would be able to access a central sign-in point provided by the framework, authenticate themselves, and proceed to access a list of their favourite/saved framework web-application links, and jump straight into these applications from there. This is useful where the user has multiple web enabled devices through which they may wish to utilise the shared application.

An alternative for those users who do not wish to create a profile within the framework would be to share the application effectively with themselves should they not have access to the original communication from the additional devices. For example, if a user received an SMS message 51 upon their smart phone 50 with the original link 52 to the web-application, then they would easily be able to access the web-application from within their smart phone itself upon the first occasion, add it to the homepage as a shortcut and so on for ease of subsequent visits, but if they wanted to later access the application from an alternative device such as their laptop, they could opt to either re-enter the link manually within the alternative device's web browser of choice, or they could simply share access 53 from within the web-application displayed upon their smart phone to themselves 54 via a means that was accessible to the alternative device, choosing this time to use email for example to share a second link to their account, so that they can now pick up their email 56 upon their laptop 55, which would contain the new link to access the web-application 57, this time from their laptop device. The capability to perform this would depend upon the settings applied during the original link provision by the web-application owner, as if only a single-use link was provided at the outset, then the recipient would not be permitted to forward to themselves, but could potentially re-type the link address into the alternative device if they chose to do so.

The SaaS framework shall provide a central management facility for the existing association of links assigned to individuals/groups of contacts with which a web-application has previously been shared. This shall provide a means by which access could later be managed for a particular individual/group of contacts, such as revoking access to a particular individual who may no longer be deemed suitable for access. In the case of where a web-application may have been shared virally to a large number of end users, suitable provisions shall be made within the framework to understand the relationships through which the web-application was shared to an end user, such that the link management capabilities can remain manageable under large quantities of shared end users in the case of needing to revoke access permissions centrally.

Details of numbers of users who both receive and follow links into the web-application and those that never accessed the web-application etc. shall be provided through reporting/analytics metrics within the framework for the benefit of the web-application owner across all of their web-applications, and also for use within the framework for the additional promotion of popular public access level web-applications. This shall also include other useful reporting metrics such as regular usage levels, peak usage, most popular device types used to access the web-application and so on, but are left to the future development and enhancement of the SaaS framework capabilities.

Recipients that do engage with the web-application following receipt of an access link shall be logged as followers of the application, whereby the web-application itself assumes the role of collating a social network group of users/followers/customers.

To share a web-application and it's content 26 with a defined audience of contacts, the originator or individual performing the sharing or forwarding can open a contacts directory 21 through a ‘Share’ toolbar facility 24 from within the web-application (automatically provided by the framework), which will allow particular individual contacts 22 to be selected for inclusion from the originator's contact address book. To share with contacts' details held within a given social network, through the same social network's messaging features, the owner or forwarding individual performing the share can choose from the list of their enabled social network profiles 23. Only those social networks that the end user has provided necessary access credentials/granted OAuth application permissions for shall appear within the user interface, in this example the end user having implemented Facebook, Google+ and Twitter only, whilst other social network integration capabilities/logos such as Pinterest, LinkedIn (list not considered to be exhaustive) could potentially appear within this list of social network sharing options.

When the application has been shared from the originating user A, to a shared user B, user B is then able to access the web-application that was shared with them 27 and optionally add the application to their home screen or bookmark it 28 within their device's web browser and then return to the application 29. Assuming the creator of the application in question, user A, has allowed data to be contributed to it by other users whom have access to the application, then a button appears within the application toolbar through which to add data 25, 30. When selected, this allows user B to enter and submit data to the web-application 31, with a confirmation of success 32.

If the creator of the application, user A, set that they wish to control and therefore moderate all contributed data, then they shall receive an alert via the framework to say that content has been submitted and is awaiting their approval. User A can then choose to approve the content if suitable 33 (they may also choose to amend the submitted content before approving it), decline the content 34, or delete it 35 if found to be duplicate or inappropriate. Deleting the content permanently removes it from the web-application's data store within the SaaS framework.

Once the content has been approved, or alternatively content contribution did not require moderation, then anybody with whom the application has been shared can now access the newly created data within the application itself 36, pending any caching mechanism that may be employed by the framework of the web-application data upon the consuming device.

Following the successful content contribution process, the framework may then be used to further promote the web-application's availability and continued use via the pushing of additional communications (similar to those used when initially sharing the application), but this time to mention that new content has been pushed and by whom within what application, in the cases that the contributor is proud of or thinks that their friends or all application users might find the content interesting or useful.

What we claim as our invention is:

1. A method for enabling forwarding and sharing of web-applications from users with whom the web-application is previously shared, through various web-enabled devices and via at least one of said user's selected networks for inviting and providing initial access to said web-application.

2. The method defined in claim 1, further comprising the steps of:
forwarding and sharing the web-application invitation via the end user's address book of contact records from within the user's device, and
affording access to the web-application via a link sent within an email message.

3. The method defined in claim 1, further comprising the steps of:
Forwarding and sharing the web-application invitation via an end user's address book of contact records from within the user's device, and
affording access to the web-application via a link sent within at least one of an SMS, MMS, and BBM communication.

4. The method defined in claim 1, further comprising the step of limiting the level of access which a user or a group of users may have to the web-application for making or suggesting changes thereto.

5. The method defined in claim 1, further comprising the step limiting the ability of users to forward access to the web-application to others of their own contacts.

6. The method defined in claim 1, further comprising the step of allowing users who have participated in the sharing of web-applications to contribute at least one of functionality and data to such web-application, thereby ‘crowd-sourcing’ aggregated data and enriching at least one of the data store and functionality of the web-application.

7. The method defined in claim 6, further comprising the step of moderating or checking users' contributed functionality and data prior to incorporating it into the web-application.

8. The method defined in claim 1, wherein the web-application invitation is forwarded via any of an end user's contacts lists, including any of said end user's social network contacts, for sharing with and affording others access to said web-application.
